(19) United States
(12) Patent Application Publication
(10) Pub. No.: US 2024/0215506 A1
(43) Pub. Date: Jul. 4, 2024

(54) LINKED CHAIN GUTTER SYSTEM FOR CONTROLLED ENVIRONMENT AGRICULTURE

(71) Applicant: Local Bounti Operating Company, LLC, Hamilton, MT (US)

(72) Inventors: Ryan SWEENEY, Hamilton, MT (US); Ari HOROWITZ, Brooklyn, NY (US)

(73) Assignee: Local Bounti Operating Company, LLC, Hamilton, MT (US)

(21) Appl. No.: 18/399,836

(22) Filed: Dec. 29, 2023

Related U.S. Application Data
(60) Provisional application No. 63/477,899, filed on Dec. 30, 2022.

(51) Int. Cl. A01G 31/02

(52) U.S. Cl. CPC A01G 31/02

(57) ABSTRACT

A linked-chain system and custom gutter within an agricultural environment may be shown and described. In an exemplary embodiment, plantlets, seedlings, plant pods, or crops may be connected to one another in a linked-chain. The linked-chain may be placed within a gutter that may be provided within a growing facility. The gutter system may include multiple gutters for receiving and growing crops. The gutters may be arranged parallel to one another. In an exemplary embodiment, the gutters may include a linked-chain of plantlets or plant plugs. Plants in a linked-chain configuration can be transplanted together. The chain of plantlets may be densely planted initially and then may be pulled apart to increase spacing as the crops grow and density increases.

### FIELD

An exemplary embodiment relates to the field of agriculture.

### BACKGROUND

Typical agricultural systems face numerous problems. For example, agriculture is typically limited to certain seasons and/or regions of the world depending on the varietal. The yield is often dependent on the environmental conditions or local weather. Large amounts of space is wasted in conventional agricultural techniques since crops need to be spaced apart based on their predicted growth, and not based on their current size. Agricultural environments also require large amounts of space to allow for humans and/or machinery to manage and harvest the crops.

Controlled environment agriculture (CEA) presents multiple solutions to the various problems facing agricultural systems. For example, nutrients may be consistently provided to the crops using a nutrient-rich water solution. Temperature and light can be adjusted to allow crops to thrive year-round in environments where they might not otherwise survive. Optimal growing conditions can be maintained independently of the surrounding environment. The growing facility may be protected from outdoor elements such as harsh temperatures and precipitation. CEA can also allow for denser planting configurations. Crops may be planted vertically and can utilize artificial light sources in order to increase output of a facility.

However, improvements to CEA systems and conventional agriculture to increase plant density, improve plant health, improve plant vigor or resilience, expedite harvest, and increase overall yield are still highly sought after. For example, it can be advantageous to further increase density of the planting facility in order to increase the total yield. Additionally, CEA systems may require transplants and adjustments that can be difficult to implement or automate.

### SUMMARY

According to at least one exemplary embodiment, a method, system and apparatus for a linked-chain and custom gutter within a controlled agricultural environment may be shown and described. In an exemplary embodiment, a gutter system may be provided within a growing facility. The gutter system may include multiple gutters for receiving and growing crops. The gutters may be arranged parallel to one another.

In an exemplary embodiment, the gutters may include a linked-chain of plantlets or plant plugs. For example, multiple plant plugs or plantlets may be connected to one another in a linked-chain.

Plants in a linked-chain configuration can be transplanted together. In an exemplary embodiment, a smaller substrate, and/or a substrate of different composition, may be used with linked plants. For example, in an exemplary embodiment, a smaller substrate may have a similar composition to those that might be used for non-linked plants, but may be reduced in volume in order to reduce environmental impact or waste; in an exemplary embodiment, a smaller substrate may contain less peat and may thus provide a reduced carbon footprint. Movement or transplant of plants within the linked chain can be accomplished by pulling one end of the chain across the gutter into another gutter or into a receptacle for transplant or harvest. Transplanting in a linked chain may result in a reduction in cost and time spent transplanting. Further, the linked chain may facilitate the automation of the transplants which can be accomplished using appropriate robotics to grasp one portion or one end of the linked chain in order to move or transplant the entire chain.

In an exemplary embodiment, a chain may be transplanted via, for example, an automated transplanting system. An example automated transplanting system may retain the linked chain in a tray, and, by grasping one portion or one end of the chain as noted, extract the linked chain in whole or in part in order to access plantlets retained on the linked chain. (Other variations may of course be contemplated, such as an automated transplanting system that uses an individual pushing finger for each plantlet in the chain.) The automated transplanting system may perform one or more modification operations on the linked chain; for example, in an exemplary embodiment, the automated transplanting system may stretch elements of the linked chain in order to adjust a spacing between plantlets on the linked chain, which may for example be performed with in-line stretching clamps or with any other stretching structure. (Alternatively, the linked chain may have elements connected via a plurality of connections which can be selectively cut in order to increase a spacing between plantlets in the chain; for example, an exemplary chain may be linked by biodegradable cellulose string or cord, with each element having a first, shorter cellulose string and a second, longer cellulose string linking it to a next element, such that severing the shorter cellulose string leaves the elements linked only by the longer cellulose string and accordingly leaves them spaced apart more widely. Any other such connections may also be contemplated, such as may be desired.) In another exemplary embodiment, the automated transplanting system may sever parts of the linked chain from other parts, or may perform multiple operations, for example stretching the chain to a new length and then severing it in half as it is dispensed so as to allow the chain to be transplanted to a similarly-sized structure while extending the spacing between plantlets, or attaching chains to one another (for example, with a biodegradable clip structure) in order to form a new chain of a desired length.

An exemplary linked-chain may accommodate a large range of plants and plant sizes. Spacing along the linked chain can be adjusted by pulling plants at one end or portion of the chain. For example, after a certain period of growth, an exemplary CEA facility may pull at the linked-chain in order to separate densely packed plants. The plants in the linked-chain within the gutter may be pulled to spread them apart from one another. It may be contemplated that a certain portion of the plants which are pulled are then transplanted to a different gutter in order to decrease the density.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a front-view of a gutter.

FIG. 2 is an exemplary embodiment illustrating two gutters with differing densities.

FIG. 3 is an exemplary embodiment of a linked-chain of plantlets.

FIG. 4 is an exemplary embodiment of a linked-chain of plantlets within a gutter.

FIG. 5 is an exemplary embodiment of an automated transplanter.

FIG. 6 is an exemplary flowchart describing an exemplary embodiment of a method of using an automated transplanter to transplant plantlets via a linked chain.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of “invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

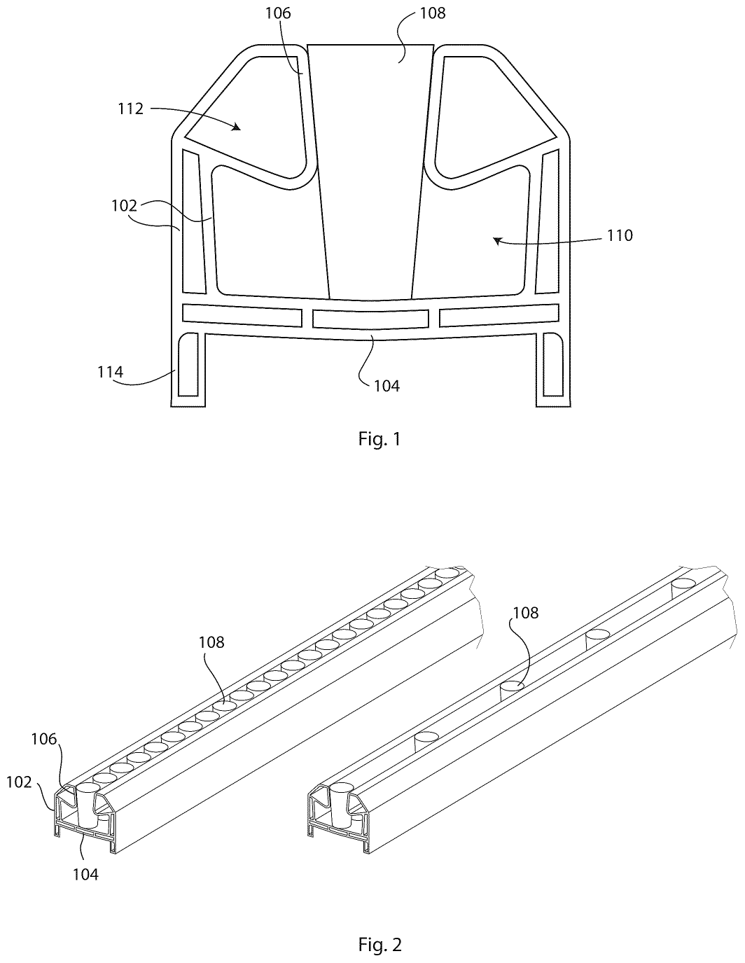

In an exemplary embodiment, a gutter system may be provided within a growing facility. FIG. 1 illustrates a side view of an exemplary gutter. The gutter 100 may be connected to a water and/or nutrient source. For example, the gutter 100 may be filled with a nutrient-rich water solution. Alternatively, a nutrient-solution may flow through the gutter 100 in one direction. The gutter 100 may thus be compatible with multiple different types of watering systems, such as a deep-water culture, a top irrigation technique, or a nutrient film technique.

The gutter 100 may be part of a gutter system that may include multiple gutters for receiving and growing crops. The gutters may be arranged parallel to one another, or arranged in an exemplary embodiment, a gutter system may be provided within a growing facility. FIG. 1 illustrates a side view of an exemplary gutter. The gutter 100 may be connected to a water and/or nutrient source. For example, the gutter 100 may be filled with a nutrient-rich water solution. Alternatively, a nutrient-solution may flow through the gutter 100 in one direction. The gutter 100s may thus be compatible with multiple different types of watering systems, such as a deep-water culture or a nutrient film technique. The gutter 100 may be part of a gutter system that may include multiple gutters for receiving and growing crops. The gutters may be arranged parallel to one another, or arranged in another manner. Crops may be placed along the interior of the gutters. In an exemplary embodiment, the plants may be in a linked-chain configuration. For example, the plants within the gutter 100 may be connected to one another. Multiple linked plants may be transplanted together through the ends of the gutters or over an open top.

Referring to FIG. 1, an exemplary gutter 100 may be shown. exemplary gutter 100 may include, for example, a double-walled sidewall 102 to provide structural integrity and for additional insulation. The double wall support on the sidewalls 102 and bottom portion 104 of the gutter 100 may reduce torsion while increasing rigidity and strength. In some embodiments the exemplary gutter 100 may be made of a plurality of hollow pieces 112. In some embodiments the gutter and/or hollow pieces 112 may be formed through, for example, extrusion molding.

The sidewall 102 may rise and bend inwards towards the top portion to form a holding portion 106 in order to contact a plant plug 108. The plant plug 108 may be held by the holding portion 106 via friction, so that there is an airgap between the bottom of the plant plug 108 and the bottom portion 104 of the gutter 100. Alternatively, the plant plug in the integrated gutter 100 may rest on the surface of the bottom of the gutter 104, and the airgap is around the plant plug 108. The gutter 100 may further have an inner trough 110, through which water or nutrients may be dispensed. The gutter 100 may further have one or more legs 114, which may allow the gutter 100 to stand freely on the ground or another surface.

Referring now to FIG. 2, FIG. 2 may illustrate an exemplary gutter system with two gutters 100 of differing densities. Plant pods or substrates on the first gutter may be placed closer to one another, while substrates on the second gutter may be spaced apart farther from one another. It may be contemplated that the plant substrate density along an exemplary gutter 100 may be adjusted. The density adjustment may be made in real-time as the crops are growing and may be based on variables identified by a control unit implementing an artificial intelligence algorithm. For example, the agricultural environment may be autonomously controlled by a computer-implemented program stored on memory and executed by one or more processors. The algorithm and control unit may receive data from various environmental sensors and cameras. An exemplary embodiment may implement computer vision to analyze camera data in real time. Sensor and camera data can then be used identify and predict future density and an optimal density to arrange the plantlets or plant plugs in. An exemplary embodiment may also include robotics that can be autonomously controlled by the control unit to take actions based on the received data, such as, for example, increasing a spacing between plant substrates. In an exemplary embodiment, the spacing may be increased by pulling a linked chain of connected plants or plantlets through the gutter.

In an exemplary embodiment, the gutters may include a linked-chain of plantlets or seedlings. For example, multiple plant plugs or plantlets may be connected to one another in a linked-chain. The plants may be connected via a line of a bio-degradable material. The bio-degradable material may be one or more of, for example but not limited to, paper (which may for example be of any grade, with exemplary embodiments including high-durability kraft paper and low-durability water-dispersible paper having similar properties to toilet paper, or any other paper selection), or other cellulose based materials such as straw, cardboard, wood, hemp, giant reed, miscanthus, eucalyptus, etc. It some embodiments the bio-degradable material may be a blend of two or more of the above; for example, a more rigid element like cardboard may be combined with a more flexible element like paper in order to provide regions with varying rigidity and flexibility. Any other bio-degradable plant-based fiber encasement or combination of such encasements that may be suitable for growing plants within the encasement may alternatively be contemplated. For example, the plants may grow within or around the material which may be wrapped around a portion of each plant or plant plug.

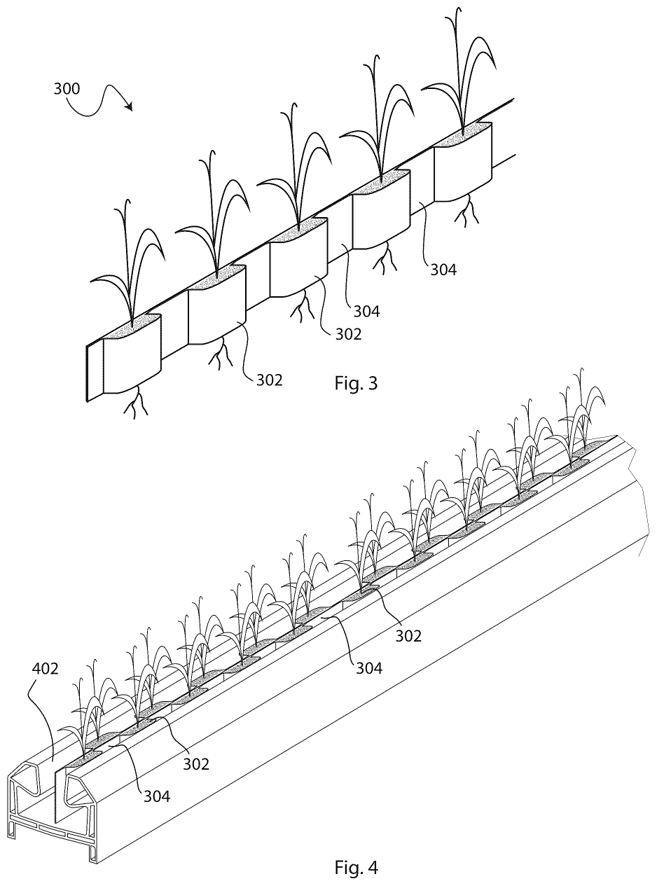

Referring now to FIG. 3, FIG. 3 may illustrate an exemplary linked chain of plantlets 300. The linked chain of plantlets 300 may include a plurality of plantlets 302, which may be of a similar size, age, and/or species. The plurality of plantlets 302 may be linked together by a biodegradable material 304. The distance between the plantlets may be pre-determined according to one or more factors including starting age of the plantlet, plant species, plant variety, expected growth rate and size, growing conditions, desired characteristics of finished goods, any other environmental aspects, etc. When initially planted, the linked chain of crops may be densely planted or placed in the growing facility. As the crops grow, they may be pulled farther apart from one another while still remaining connected. The plants may be re-spaced any number of times, for example based on a set schedule (daily, once a week, twice a month, etc.) or based on detection of attributed of the plants, e.g. the plants growing to a predetermined size, or the space between the plants reaching a predetermined length etc. As with initial spacing of plants, re-spacing of plants may potentially be performed based on numerous factors, including those discussed with respect to initial spacing such as age of the plantlet, plant variety, desired characteristics of finished goods, environmental aspects, and so forth.

In an exemplary embodiment, crops may be placed in a germination facility as a linked chain. The linked chain may be densely packed into the germination facility or growing area to eliminate wasted space between the crops or plant plugs. Then, after the crops have achieved some level of growth, they may be transplanted into a subsequent facility, such as a nursery or greenhouse, where they may be placed in a gutter.

FIG. 4 illustrates an exemplary embodiment with a linked chain of crops or plantlets placed within a gutter. As shown in the example in FIG. 4, the linked chain may extend along the length of the gutter. When the linked chain is initially dispersed into the gutter system, The crops may be closely planted. As the plants continue growing and the crop density within the gutters increases, the linked chain may be pulled or stretched in order to increase the spacing between crops.

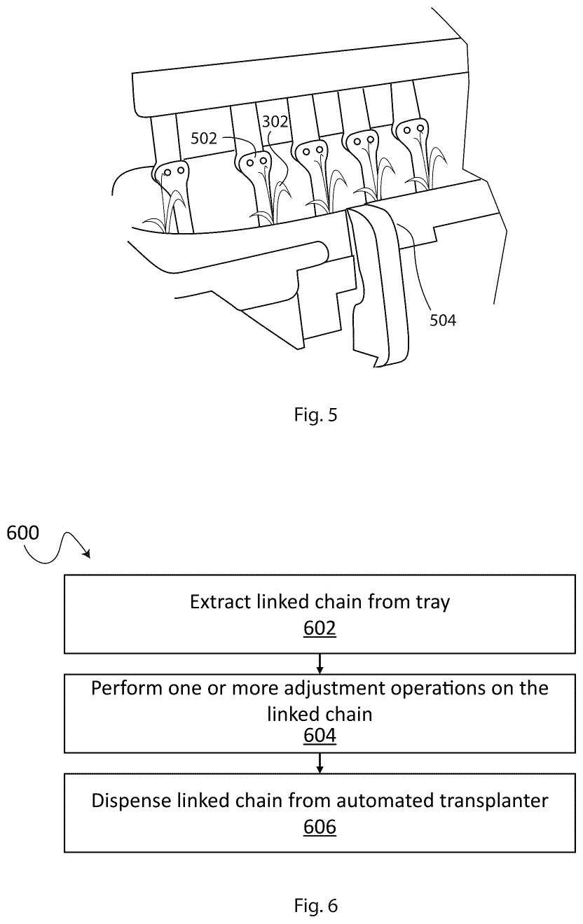

Plants in a linked-chain configuration can be transplanted together. Linked plants can be transplanted with a smaller substrate as compared to traditional plants which require a larger substrate in order to be properly grasped and transplanted. Movement or transplant of plants within the linked chain can be accomplished by pulling one end of the chain across the gutter into another gutter or into a receptacle for transplant or harvest, for example through the use of robotics. Transplanting in a linked chain may result in a reduction in cost and time spent transplanting. Further, the linked chain may facilitate the automation of the transplants which can be accomplished using appropriate robotics to grasp one portion or one end of the linked chain in order to move or transplant the entire chain. A mechanical system may be in place to transfer the connected string of plants to a gutter. This may be accomplished by, for example, pulling a string of plants into a static gutter. Alternatively, a string or line of tape may be placed a gutter while the gutter is in movement through a dedicated in-line system. FIG. 5 illustrates an exemplary automated transplanter, which may be configured to advance a linked chain 300 of plantlets by the use of a plurality of pushing fingers 502, which may be configured to interface with the linked chain 300 at one or more locations such as in gaps between plantlets in order to advance the linked chain 300 along a track 504.

Turning now to FIG. 6, FIG. 6 provides an exemplary flowchart describing an exemplary embodiment of a method 600 of using an automated transplanting mechanism to transplant plantlets via a linked chain. In a first step 602, the linked chain may be extracted from a tray or other retention site in which it is retained. In a second step 604, the automated transplanter may perform one or more adjustment operations on the linked chain, such as cutting a continuous linked chain to sever a transplantable section, stretching a section of linked chain in order to adjust a spacing between plantlets, or linking elements of a linked chain together, for example via a biodegradable clip or an adhesive, in order to form a new longer linked chain. In a third step 606, the linked chain may be dispensed, for example via the action of pushing fingers acting to move the linked chain along rollers such as is discussed above.

An exemplary linked-chain may accommodate a large range of plants and may be dynamically adjustable. For example, adjustments may be made to the spacing within the gutter during the growth cycle, as determined by an artificial intelligence or CEA control unit. Spacing along the linked chain can be adjusted by pulling plants at one end or portion of the chain. For example, after a certain period of growth, an exemplary CEA facility may pull at the linked-chain in order to separate densely packed plants. The plants in the linked-chain within the gutter may be pulled to spread them apart from one another. It may be contemplated that a certain portion of the plants which are pulled are then transplanted to a different gutter in order to decrease the density.

An exemplary embodiment may implement multiple sensors to identify variables associated with plants growing in a hybrid growing environment. For example, multiple independent variables may be measured and controlled by an exemplary embodiment, while dependent variables may change according to the independent variables and may be measured accordingly. Growing conditions and growing duration may be changed based on target dependent variables in the growing process.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

1-40. (canceled)

41. A system for growing plants, comprising:
a plurality of plantlets;
a biodegradable chain linking together the plurality of plantlets.

42. The system of claim 41, wherein the biodegradable chain linking is comprised of one or more biodegradable cellulose materials.

43. The system of claim 42, wherein the one or more biodegradable cellulose materials include at least one of paper, straw, cardboard, wood, hemp, giant reed, miscanthus, and eucalyptus.

44. The system of claim 41, wherein a plurality of plant plugs are retained within the biodegradable chain, wherein each of the plurality of plantlets is retained within a respective plant plug in the plurality of plant plugs.

45. The system of claim 41, further comprising a gutter that holds the plurality of plantlets, wherein the gutter further comprises;
a trough;
a first side wall extending upward from the trough; and
a second side wall opposite the first side wall and extending upward from the trough.

46. The system of claim 45, further comprising a plurality of plant plugs, wherein each of the plurality of plantlets is retained within a respective plant plug in the plurality of plant plugs, and wherein each respective plant plug in the plurality of plant plugs is retained in the gutter via at least one of:
a friction fit between the respective plant plug, the first side wall, and the second side wall; and
a surface provided on a bottom of the gutter having an airgap defined around said surface.

47. The system of claim 41, wherein the plantlets are held between the first side wall and the second side wall of the gutter.

48. The system of claim 47, wherein there is an air gap underneath each of the plurality of plantlets.

49. The system of claim 47, wherein the bottom of the plantlets rests on the trough.

50. The system of claim 45, wherein water and/or plant nutrients are configured to run through the trough.

51. The system of claim 45, wherein the gutter further comprises a first leg and a second leg extending downwards from the trough.

52. The system of claim 45, wherein each of the first side wall and the second side wall is a double walled structure having a hollow interior defined within said double walled structure.

53. The system of claim 41, further comprising one or more grasping mechanisms configured to pull on the biodegradable chain linking so that the space between the plantlets is increased.

54. The system of claim 53, wherein the grasping mechanism is a robotic arm.

55. The system of claim 53, further comprising one or more sensors configured to monitor one or more plantlets in the plurality of plantlets to determine at least one sensor reading, said at least one sensor reading comprising a measured growth of the one or more plantlets; and
at least one processor, said at least one processor configured to control the grasping mechanism;
wherein the processor is configured to control the grasping mechanism to pull on the biodegradable chain linking at least based on the measured growth of the one or more plantlets.

56. The system of claim 55, wherein the grasping mechanism is further controlled by at least an AI.

57. A method for transplanting plants to be grown, comprising:
providing the plants as a plurality of plantlets in a biodegradable chain linking together the plurality of plantlets;
retaining the biodegradable chain in a storage of an automated transplanter;
removing, via the automated transplanter, the biodegradable chain from the storage, and performing one or more adjustment operations on the biodegradable chain via the automated transplanter; and
transplanting the plants by dispensing the linked chain from the automated transplanter into a plant environment.

58. The method for transplanting plants of claim 57, wherein the one or more adjustment operations comprise one of:
linking two or more smaller chains into the biodegradable chain;
cutting a longer chain to form the biodegradable chain; and
stretching the biodegradable chain to adjust a spacing between plantlets in the biodegradable chain.

59. The method for transplanting plants of claim 57, wherein the automated transplanter comprises at least one of a clamping or pushing element configured to grip the biodegradable chain and advance the biodegradable chain within the automated transplanter.

60. The method for transplanting plants of claim 59, wherein the automated transplanter comprises a plurality of pushing fingers.
